(19) United States
(12) Patent Application Publication
(10) Pub. No.: US 2024/0347230 A1
(43) Pub. Date: Oct. 17, 2024

(54) LOW NOISE CABLE CORE AND MANUFACTURING METHOD THEREOF AND LOW NOISE CABLE USING THE SAME

(71) Applicant: Dongguan Ching Tai Electric Wire & Cable Co., Ltd., Dongguan City (CN)

(72) Inventors: Yang Zhou, Dongguan City (CN); Wen-Cheng Wu, Dongguan City (CN); Shi-Wen Huang, Dongguan City (CN)

(21) Appl. No.: 18/636,727

(22) Filed: Apr. 16, 2024

(30) Foreign Application Priority Data
Apr. 17, 2023 (CN) 202310408603.4

(51) Int. Cl. H01B 11/18; H01B 1/12; H01B 13/016

(52) U.S. Cl. CPC H01B 11/1817; H01B 13/0165; H01B 1/124

(57) ABSTRACT

A low noise cable core and a manufacturing method thereof and a low noise cable using the same include an insulated conductor, a first type conductive layer, and a second type conductive layer. The insulated conductor includes a conductive core and an insulation layer encapsulating the conductive core. The first type conductive layer encapsulates the insulated conductor, and the second type conductive layer encapsulates the first type conductive layer. The first type conductive layer and the second type conductive layer are respectively formed by way of a first forming method and a second forming method different from the first forming method.

### CROSS-REFERENCE TO RELATED APPLICATION

This application claims priority to Chinese patent application No. 202310408603.4, filed Apr. 17, 2023, titled “LOW NOISE CABLE CORE AND MANUFACTURING METHOD THEREOF AND LOW NOISE CABLE USING THE SAME” by Zhou et al., which is hereby incorporated by reference in its entirety.

### BACKGROUND OF THE INVENTION

### Technical Field

The present invention relates to a cable core structure in a cable. More particularly, the present invention relates to a low noise cable core and manufacturing method thereof and low noise cable using the same.

### Description of Related Art

With the development of monitoring and inspecting technology, a higher technical level has been reached in various technological fields. The variety and the number of detectable signals are greatly increased as well. Modern monitoring technology mainly includes sensors, cables, amplifiers, and other components. These components coordinate with each other in practical use, and they evolve together with the development of technology, so that the overall detection quality can be improved. Such technology has been widely implemented in the military and civilian use like aviation and space industry, nuclear power industry, navigation/guidance technology, medical technology, and the field of industrial automation.

Particularly, in the field of medical technology, when monitoring or detecting the patients' electrocardiograms, a key to correct diagnosis is the quality of the signals picked up by the monitoring instruments. Since the diagnosis is critical to the life of the patients, the signal noise requirement to the instruments and the cables used has a stricter standard.

Therefore, how to effectively reduce the noise interference for the cables is an important technical problem that needs to be solved.

### SUMMARY

In view of the above-mentioned problems, the present invention is to provide a low noise cable core and manufacturing method of the cable core and a cable using the cable core. Different conductive layers of the cable core are formed by different forming methods, so as to effectively reduce the noise of the cable and to improve the signal transmission quality.

According to one aspect of the invention, a low noise cable core is provided. The cable core includes an insulated conductor, a first type conductive layer, and a second type conductive layer. The insulated conductor includes a conductive core and an insulation layer encapsulating the conductive core. The first type conductive layer encapsulates the insulated conductor, and the second type conductive layer encapsulates the first type conductive layer. The first type conductive layer and the second type conductive layer are respectively formed by way of a first forming method and a second forming method different from the first forming method.

In one embodiment, the first type conductive layer is an extruded layer, and the second type conductive layer is a coating layer. The first forming method includes an extrusion process, and the second forming method includes a solution-coating process.

In one embodiment, the first type conductive layer is a layer of extruded conductive PVC, a layer of extruded conductive PE, or a layer of extruded TPE.

In one embodiment, a coating solution used in the solution-coating process for forming the second type conductive layer includes: (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) in the coating solution is no less than 3% and the volume percentage of (b) in the coating solution is no less than 20%.

In one embodiment, the first type conductive layer is a coating layer, and the second type conductive layer is an extruded layer. The first forming method includes a solution-coating process, and the second forming method comprises an extrusion process.

In one embodiment, a coating solution used in the solution-coating process for forming the first type conductive layer includes: (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) in the coating solution is no less than 3% and the volume percentage of (b) in the coating solution is no less than 20%.

In one embodiment, the second type conductive layer is a layer of extruded conductive PVC, a layer of extruded conductive PE, or a layer of extruded TPE.

In one embodiment, the method further includes: a metal shielding layer encapsulating the second type conductive layer.

According to another aspect of the invention, a manufacturing method of a low noise cable core is provided. The method includes: forming an insulated conductor including a conductive core and an insulation layer encapsulating the conductive core; forming a first type conductive layer encapsulating the insulated conductor by way of a first forming method; and forming a second type conductive layer encapsulating the first type conductive layer by way of a second forming method different from the first forming method.

In one embodiment, the first forming method includes an extrusion process, and the second forming method includes a solution-coating process.

In one embodiment, the solution-coating process includes the following steps. A coating solution is coated on the first type conductive layer and the coating solution includes: (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) in the coating solution is no less than 3% and the volume percentage of (b) in the coating solution is no less than 20%. Then, the coating solution is dried to form a cured layer, and the cured layer is the second type conductive layer.

In one embodiment, the first forming method includes a solution-coating process, and the second forming method includes an extrusion process.

In one embodiment, the solution-coating process includes the following steps. A coating solution is coated on the insulated conductor. The coating solution includes: (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) in the coating solution is no less than 3% and the volume percentage of (b) in the coating solution is no less than 20%. Then, the coating solution is dried to form a cured layer. The cured layer is the first type conductive layer.

According to yet another aspect of the invention, a low noise cable is provided. The low noise cable includes at least three strands of cable cores, and an outer sheath encapsulates these strands of cable cores. Among the cable cores, two or more of the adjacent ones are in contact with one another. Each cable core includes an insulated conductor, a first type conductive layer, and a second type conductive layer. The insulated conductor includes a conductive core, and an insulation layer encapsulates the conductive core. The first type conductive layer encapsulates the insulated conductor, and the second type conductive layer encapsulates the first type conductive layer. The first type conductive layer and the second type conductive layer are respectively formed by way of a first forming method and a second forming method different from the first forming method.

According to the aspects and the embodiments of the invention, the low noise cable core and manufacturing method thereof and the low noise cable using the same have the following advantages. The first and second type conductive layers are formed by different forming methods. In the manner that the two conductive layers are in turn formed on the insulated conductor, the noise of the cable can be reduced, and the quality of signal transmission can be improved.

### BRIEF DESCRIPTION OF DRAWINGS

The invention can be more fully understood by reading the following detailed description of the embodiment, with reference made to the accompanying drawings as follows:

FIG. 1 is a schematic diagram of a low noise cable core of a first embodiment of the invention;

FIG. 2 is a schematic diagram of a low noise cable core of a second embodiment of the invention;

FIG. 3 is a schematic diagram of a low noise cable core of a third embodiment of the invention;

FIG. 4 is a schematic diagram of a low noise cable core of a fourth embodiment of the invention;

FIG. 5 is a schematic diagram of a low noise cable of a fifth embodiment of the invention;

FIG. 6 is a schematic diagram of a low noise cable of a sixth embodiment of the invention;

FIG. 7 is a schematic diagram of a low noise cable of a seventh embodiment of the invention;

FIG. 8 is a schematic diagram of a low noise cable of an eighth embodiment of the invention;

FIG. 9 is a schematic diagram of a low noise cable of a ninth embodiment of the invention;

FIG. 10 is a flow chart of a manufacturing method of a low noise cable core according to one embodiment of the invention;

FIG. 11 is a flow chart of a second forming method according to one embodiment of the invention; and

FIG. 12 is a flow chart of a first forming method according to another embodiment of the invention.

### DETAILED DESCRIPTION

The embodiments of the present invention will be elaborated in the below with accompanying drawings. The technical features for achieving one or more purposes of the invention are described herein. A person who skilled in the art would understand the terms used in the detailed description such as “up”, “down”, “left”, “right”, “back”, and “front” are for elaboration in accordance with the orientation of the drawings and are not for limiting the invention. Besides that, the person can perform a variety of modifications and alterations without departing from the spirit and scope of the invention. The embodiments and examples derived therefrom will still consider falling in the scope of the present invention.

According to the embodiments of the invention, a low noise cable core and a manufacturing method thereof and a low noise cable using the same are provided so that the noise of the cable can be reduced, and the signal transmission quality can be improved, which is advantageous for using in the field of high precision signal detection like medical use.

Embodiment 1 is elaborated below.

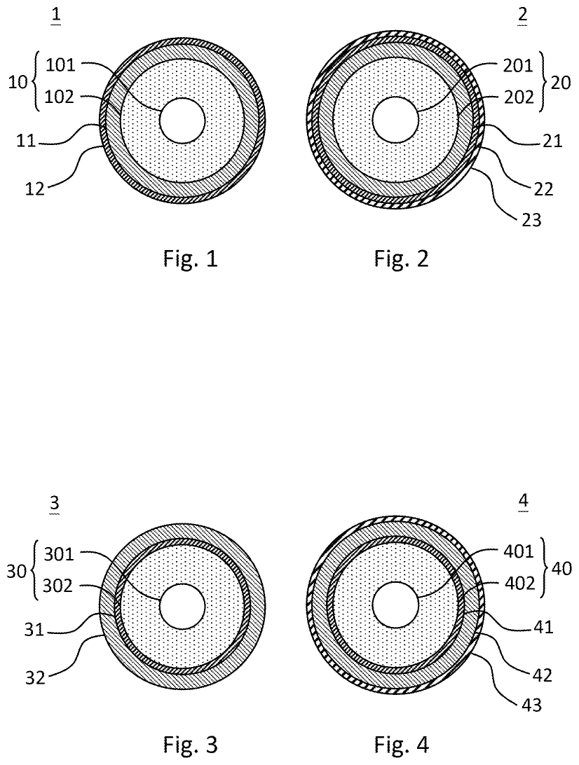

Please refer to FIG. 1, which is a schematic diagram of a low noise cable core of a first embodiment of the invention. The cable core 1 includes an insulated conductor 10, a first type conductive layer 11, and a second type conductive layer 12. The insulated conductor 10 includes a conductive core 101 and an insulation layer 102 encapsulating the conductive core 101. The first type conductive layer 11 encapsulates the insulated conductor 10 and is formed by way of a first forming method. The second type conductive layer 12 encapsulates the first type conductive layer 11 and is formed by way of a second forming method.

The conductive core 101 can be a bare copper conductor, a tin-plated copper conductor, a silver-plated copper conductor, a bare silver conductor, a tin-copper alloy conductor, or a silver-copper alloy conductor. The insulation layer 102 covering the conductive core 101 can be exemplified by polypropylene (PP), polyethylene (PE), polyvinyl chloride (PVC), or fluoroplastic. The insulated conductor 10 can be made by selecting from the above-mentioned exemplary materials or other suitable materials.

In one embodiment, the first type conductive layer 11 of the cable core 1 is an extruded layer and the first forming method includes an extrusion process, while the second type conductive layer 12 is a coating layer and the second forming method includes a solution-coating process where a coating solution is used to be coated onto the first type conductive layer 11. In the embodiment, the first type conductive layer 11 is a layer of extruded conductive PVC, a layer of extruded conductive PE, or a layer of extruded TPE formed on the insulated conductor 10 (on the insulation layer 102 to be exact). In the present embodiment, the second type conductive layer 12 is formed by coating the coating solution onto the first type conductive layer 11 and then drying the coating solution. The coating solution at least includes graphite or graphene. In this first embodiment, the coating solution used in the solution-coating process for forming the second type conductive layer 12 includes (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) graphite or graphene in the coating solution is no less than 3% and the volume percentage of (b) ethyl acetate, N,N-dimethylformamide, cyclohexanone, or Ethylene glycol monoethyl acetate in the coating solution is no less than 20%. After drying the coating solution, a cured layer is formed on the first type conductive layer 11, and the cured layer is the second type conductive layer 12.

Embodiment 2 is elaborated below.

Please refer to FIG. 2, which is a schematic diagram of a low noise cable core of a second embodiment of the invention. The cable core 2 includes an insulated conductor 20, a first type conductive layer 21 formed by way of a first forming method, and a second type conductive layer 22 formed by way of a second forming method. The insulated conductor 20 includes a conductive core 201 and an insulation layer 202 encapsulating the conductive core 201. The first type conductive layer 21 encapsulates the insulated conductor 20, and the second type conductive layer 22 encapsulates the first type conductive layer 21. In the present embodiment, the first type conductive layer 21 is an extruded layer and the second type conductive layer 22 is a coating layer, and their respective forming methods are the same as those described in the above-mentioned cable core 1 of first embodiment and will not be repeated here.

The cable core 2 of the present embodiment further includes a metal shielding layer 23 encapsulating the second type conductive layer 22. The material of the metal shielding layer 23 can be exemplified by a metal conductor or a shielding tape combining metal and non-metal materials, such as aluminum foil polyester film (e.g. Mylar®), copper foil polyester film, or semiconductive tape. The metal shielding layer 23 can improve the shielding effect for external interference.

According to the above-mentioned first and second embodiment, the low noise cable core 1 and 2 mainly includes the insulted conductor 10, 20, the first type conductive layer 11, 21, and the second type conductive layer 12, 22. The metal shielding layer 23 of the cable core 2 of the second embodiment is an optional layer, and can be optionally used in the cable core 2 based on actual product needs.

Embodiment 3 is elaborated below.

Please refer to FIG. 3, which is a schematic diagram of a low noise cable core of a third embodiment of the invention. The cable core 3 includes an insulated conductor 30, a first type conductor layer 31, and a second type conductor layer 32. The insulated conductor 30 includes a conductive core 301 and an insulation layer 302 encapsulating the conductive core 301. The first type conductive layer 31 encapsulates the insulated conductor 30 and is formed by way of a first forming method. The second type conductive layer 32 encapsulates the first type conductive layer 31 and is formed by way of a second forming method different from the first forming method.

The cable core 3 is different from the cable core 1, 2 of the previous embodiments in that, the first type conductive layer 31 of the present embodiment is a coating layer, and the second type conductive layer 32 is an extruded layer. The first forming method includes a solution-coating process, and the second forming method includes an extrusion process. The coating solution used in the solution-coating process to form the first type conductive layer 31 includes (a) polyester resin, (b) ethyl acetate, N,N-dimethylformamide, cyclohexanone, or Ethylene glycol monoethyl acetate, (c) graphite or graphene, and (d) Chemical additives. The volume percentage of (c) in the coating solution is no less than 3% and the volume percentage of (b) in the coating solution is no less than 20%. After drying the coating solution, a cured layer is formed on the insulated conductor 30 (on the insulation layer 302 to be exact), and the cured layer is the first type conductive layer 31. The second type conductive layer 32 is a layer of extruded conductive PVC, a layer of extruded conductive PE, or a layer of extruded TPE formed on the first type conductive layer 31.

Embodiment 4 is elaborated below.

Please refer to FIG. 4, which is a schematic diagram of a low noise cable core of a fourth embodiment of the invention. The cable core 4 of the present embodiment includes an insulated conductor 40, a first type conductive layer 41 formed by a first forming method, and a second type conductive layer 42 formed by a second forming method. The insulated conductor 40 includes a conductive core 401 and an insulation layer 402 encapsulating the conductive core 401. The first type conductive layer 41 encapsulates the insulated conductor 40 and is formed by way of a first forming method. The second type conductive layer 42 encapsulates the first type conductive layer 41 and is formed by way of a second forming method different from the first forming method. The first type conductive layer 41 of the present embodiment is a coating layer, and the second type conductive layer 42 is an extruded layer. Their respective forming methods are the same as that of the cable core 3 of the above-mentioned third embodiment and will not be repeated here. The cable core 4 of the present embodiment further includes a metal shielding layer 43 encapsulating the second type conductive layer 42. The material of the metal shielding layer 23 can be exemplified by a metal conductor or a shielding tape combining metal and non-metal materials, such as aluminum foil polyester film (e.g. Mylar®), copper foil polyester film, or semiconductive tape.

According to the above-elaborated embodiments, the first type conductive layer and the second type conductive layer of the cable core are formed by different forming methods, so as to reduce the noise of the cable core and improve the signal transmission quality thereof. The cable using the low noise cable core is complied with ANSI/AAMI EC53 regulations.

The detailed description now directs to low noise cables using low noise cable cores.

Embodiment 5 is elaborated below.

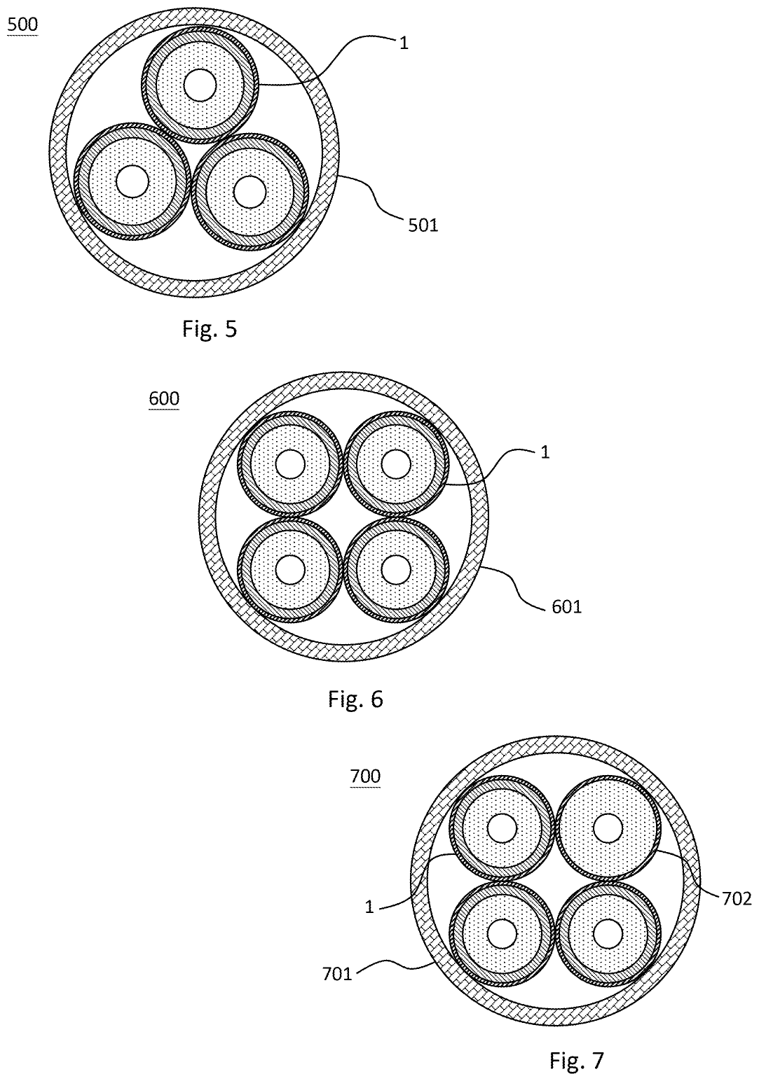

Please refer to FIG. 1 and FIG. 5 at the same time. FIG. 5 is a schematic diagram of a low noise cable of a fifth embodiment of the invention. The cable core 1 of the first embodiment is used here in the low noise cable 500 as an example. The low noise cable 500 includes at least three strands of cable cores 1 and two or more of the adjacent cable cores 1 are in contact with one another. Each cable core 1 includes the insulated conductor 10, the first type conductive layer 11, and the second type conductive layer 12 as shown in FIG. 1. The insulated conductor 10 includes the conductive core 101 and the insulation layer 102 encapsulating the conductive core 101. The first type conductive layer 11 encapsulates the insulated conductor 10 and is formed by way of the first forming method. The second type conductive layer 12 encapsulates the first type conductive layer 11 and is formed by way of the second forming method different from the first forming method. The low noise cable 500 further includes an outer sheath 501 encapsulates these cable cores 1 to protect them and separate them from the outside environment.

As mentioned above, in the first embodiment, the first type conductive layer 11 of the cable core 1 is a protruded layer and the second type conductive layer 12 is a solution-coating layer. In an alternative embodiment, instead of using the cable core 1, the low noise cable 1 can use the low noise core 3 as described in the third embodiment in the cable structure, where the first type conductive layer 31 of the cable core 3 is a solution-coating layer and the second type conductive layer 32 is an extruded layer.

Alternatively, in the structure of the low noise cable 500, the cable core 1 can further include the optional metal shielding layer 23 (as described in embodiment 2 and embodiment 4) to improve the shielding effect for external interference.

Embodiment 6 is elaborated below.

Please refer to FIG. 6, which is a schematic diagram of a low noise cable of a sixth embodiment of the invention. The cable core 1 of the first embodiment is used in the low noise cable 600 of the present embodiment. However, the cable core 2, 3, or 4 of the second, third, or fourth embodiment can also be used here. Other alternations or combinations of different cable cores from different embodiments can also be used. The cable 600 includes four strands of cable cores 1, and two adjacent cable cores 1 are in contact with one another. The structure of each cable core 1 is the same as that of the previously described embodiments and will not be repeated here. The cable 600 further includes an outer sheath 601 encapsulating the four strands of cable cores 1 to protect them and separate them from the outside environment.

Embodiment 7 is elaborated below.

Please refer to FIG. 7, which is a schematic diagram of a low noise cable of a seventh embodiment of the invention. The cable core 1 of the first embodiment is used in the low noise cable 700 of the present embodiment. However, the cable core 2, 3, or 4 of the second, third, or fourth embodiment can also be used here. Other alternation or combinations of different cable cores from different embodiments can also be used. The cable 700 includes three strands of cable cores 1 and two adjacent cable cores 1 are in contact with one another. The structure of each cable core 1 is the same as that of the previously described embodiments and will not be repeated here. The cable 700 further includes an outer sheath 701 encapsulating the three strands of cable cores 1. The cable 700 of the present embodiment is different from the cable 600 of the sixth embodiment (as shown in FIG. 6) in that the cable 700 further includes one strand of heterogenous cable core 702. This heterogenous cable core 702 has different property, structure, and/or function than the cable core 1. For instance, the heterogenous cable core 702 is used to transmit signals different from that of the cable core 1, or it is a semi-product of twisted pair. It can also simply be a filler to be filled in the outer sheath 701 to maintain the diameter of the cable 700 or to increase the mechanical strength of the cable 700, thereby holding the configuration of the cable cores 1 so that the adjacent ones can be kept in contact with one another.

Embodiment 8 is elaborated below.

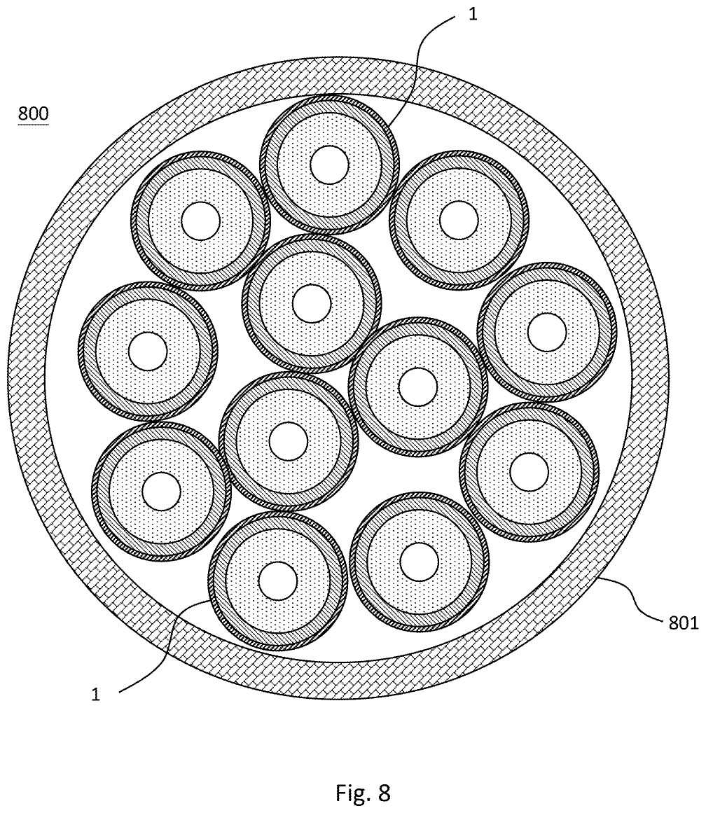

Please refer to FIG. 8, which is a schematic diagram of a low noise cable of an eighth embodiment of the invention. The cable 800 includes twelve strands of cable cores 1, and at least two adjacent cable cores 1 are in contact with one another. The cable 800 further includes an outer sheath 801 encapsulating the twelve strands of cable cores 1.

Embodiment 9 is elaborated below.

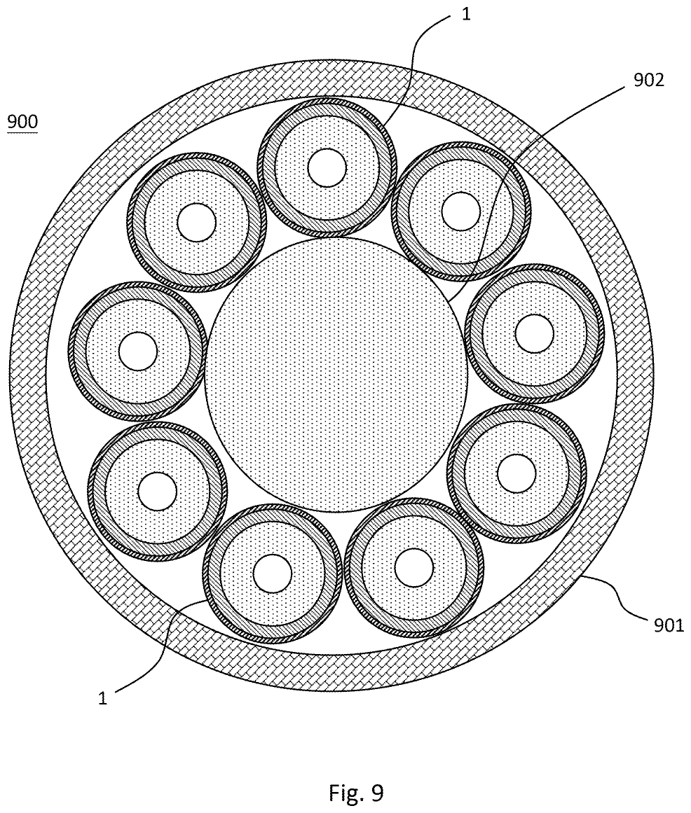

Please refer to FIG. 9, which is a schematic diagram of a low noise cable of a ninth embodiment of the invention. The cable 900 includes nine strands of cable cores 1, and at least two adjacent cable cores 1 are in contact with one another. The cable 900 further includes a supporting structure 902 which is exemplarily made of plastic. The supporting structure 902 is regarded as a filler which is filled in the outer sheath 901 of the cable 900 to maintain the diameter of the cable 900 or to increase the mechanical strength of the cable 900, thereby holding the configuration of the cable cores 1 so that the adjacent ones can be kept in contact with one another. The supporting structure 902 is not limited to the shape of a circle as the cross-section shown in FIG. 9. Other shapes such as a cross shape, I shape, T shape, or other equivalent or similar shapes with the same function can be implemented in the present embodiment of the invention.

Embodiments of the manufacturing methods are elaborated below.

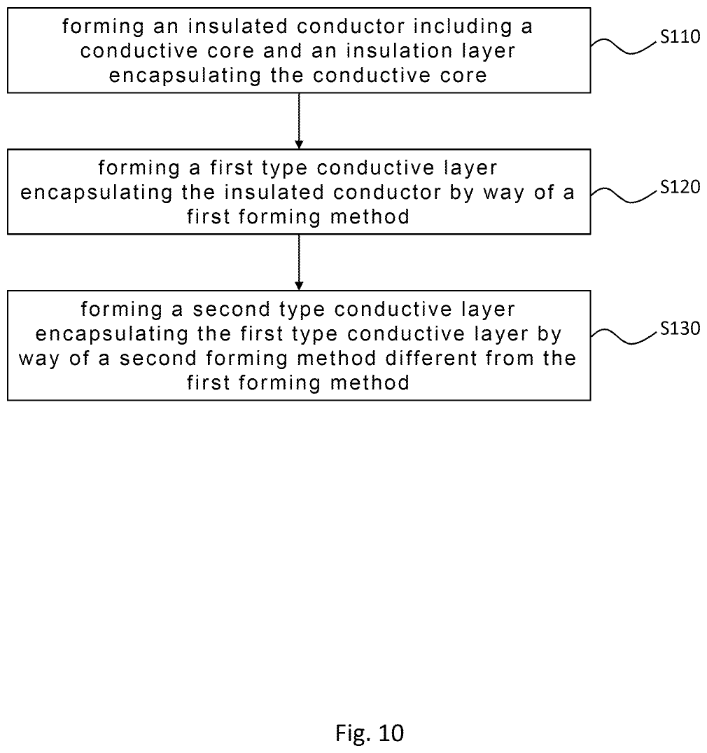

Please refer to FIG. 10, which is a flow chart of a manufacturing method of a low noise cable core according to one embodiment of the invention. The manufacturing method of the present embodiment begins with step S110.

Step S110: an insulated conductor including a conductive core and an insulation layer encapsulating the conductive core is formed.

Step S120: a first type conductive layer encapsulating the insulated conductor is formed by way of a first forming method.

Step 130: a second type conductive layer encapsulating the first type conductive layer is formed by way of a second forming method different from the first forming method.

The second forming method is different from the first one. In the present embedment, the first forming method includes an extrusion process, and the second forming method includes a solution-coating process where a coating solution is coated onto the first type conductive layer.

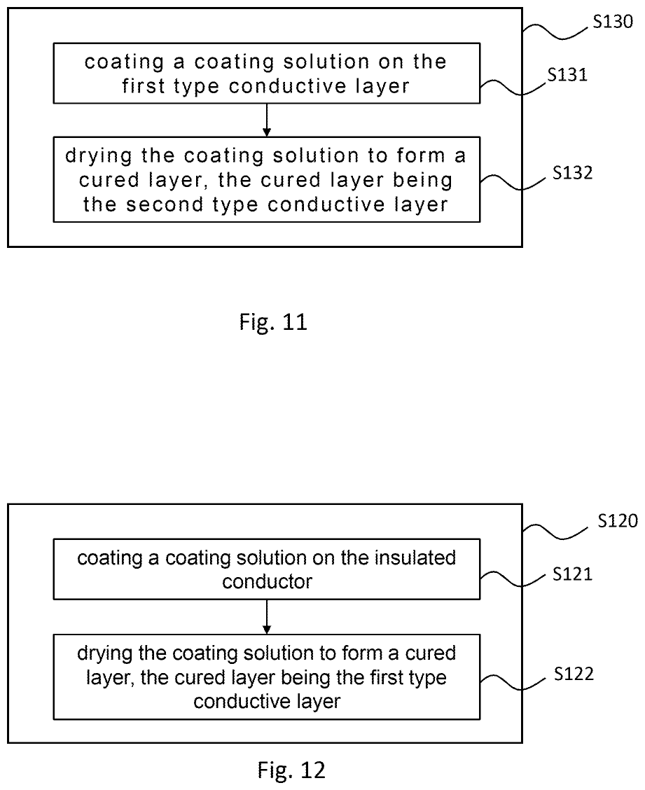

Please refer to FIG. 11, which is a flow chart of a second forming method according to one embodiment of the invention. The second forming method includes the following steps.

Step S131: the coating solution is coated onto the first type conductive layer, and the coating solution includes: (a) polyester resin, (b) ethyl acetate, N,N-dimethylformamide, cyclohexanone, or Ethylene glycol monoethyl acetate, (c) graphite or graphene, and (d) Chemical additives; in which, the volume percentage of (c) in the coating solution is no less than 3% and the volume percentage of (b) in the coating solution is no less than 20%. The method then moves on to step S132.

Step S132: the coating solution is dried to form a cured layer, and the cured layer is the second type conductive layer. The drying process of step S132 can be performed by a heater, a furnace, or other heating devices. Other devices that can dry the coating solution can be used here as well, and their types and configurations are not limited herein.

The cable core is completed. The cable core can be regarded as a semi-product and sent to the subsequent manufacturing process of the low noise cable to complete the cable product.

In another embedment, the first forming method includes a solution coating process where a coating solution is coated on the insulated conductor, and the second forming method includes an extrusion process.

Please refer to FIG. 12, which is a flow chart of a first forming method according to another embodiment of the invention. The first forming method includes the following steps.

Step S121: the coating solution is coated onto the insulated conductor, and the coating solution includes: (a) polyester resin, (b) ethyl acetate, N,N-dimethylformamide, cyclohexanone, or Ethylene glycol monoethyl acetate, (c) graphite or graphene, and (d) Chemical additives; in which, the volume percentage of (c) in the coating solution is no less than 3% and the volume percentage of (b) in the coating solution is no less than 20%. The method then moves on to step S122.

Step S122: the coating solution is dried to form a cured layer, and the cured layer is the first type conductive layer. The drying process of step S122 can be performed by a heater, a furnace, or other heating devices. Other devices that can dry the coating solution can be used here as well, and their types and configurations are not limited herein.

Then the second type conductive layer is formed by way of the second forming method including the extrusion process, so that the second type conductive layer encapsulates the first type conductive layer.

The cable core is completed. The cable core can be regarded as a semi-product and sent to the subsequent manufacturing process of the low noise cable to complete the cable product. The completed low noise cable is complied with ANSI/AAMI EC53 regulations.

According to the above-mentioned embodiments of the invention, the low noise cable core and the low noise cable can reduce the noise of the cable and/or cable core, which is advantageous while being used in the technical field that has a stricter requirement for signal noises, such as the field of medical monitoring and electrocardiogram detection. Further, the signal transmission quality can be improved as well. In the embodiments of the invention, three to twelve strands of cable cores are detailed as examples; however, one skilled in the related field could understand that the number of cable cores are not limited thereto. In fact, the number of cable cores can be changed based on actual product needs. Also, the configuration of the cable cores is not limited to those shown in the figures of the embodiments. Moreover, a metal shielding layer encapsulating the second type conductive layer can be optionally added as needed, to further enhance the shielding effect for external interference.

The low noise cable core and the manufacturing method thereof and the low noise cable using the same use the first type conductive layer and the second type conductive layer of different forming methods to reduce the noises and to increase the quality of signal transmission.

The embodiments of the invention are intended for elaboration. It will be apparent to those skilled in the art that various modifications and variations can be made to the embodiments of the present invention without departing from the scope or spirit of the invention. In view of the foregoing, it is intended that the present invention covers modifications and variations of this invention, provided they fall within the scope of the following claims.

What is claimed is:

1. A low noise cable core, comprising:
an insulated conductor comprising a conductive core and an insulation layer encapsulating the conductive core;
a first type conductive layer encapsulating the insulated conductor; and
a second type conductive layer encapsulating the first type conductive layer;
wherein the first type conductive layer and the second type conductive layer are respectively formed by way of a first forming method and a second forming method different from the first forming method.

2. The low noise cable core according to claim 1, wherein the first type conductive layer is an extruded layer, and the second type conductive layer is a coating layer, wherein the first forming method comprises an extrusion process and the second forming method comprises a solution-coating process.

3. The low noise cable core according to claim 2, wherein the first type conductive layer is a layer of extruded conductive PVC, a layer of extruded conductive PE, or a layer of extruded TPE.

4. The low noise cable core according to claim 2, wherein a coating solution used in the solution-coating process for forming the second type conductive layer comprises: (a) polyester resin, (b) ethyl acetate, N,N-dimethylformamide, cyclohexanone, or Ethylene glycol monoethyl acetate, (c) graphite or graphene, and (d) Chemical additives;
wherein a volume percentage of (c) in the coating solution is no less than 3% and a volume percentage of (b) in the coating solution is no less than 20%.

5. The low noise cable core according to claim 1, wherein the first type conductive layer is a coating layer, and the second type conductive layer is an extruded layer, wherein the first forming method comprises a solution-coating process and the second forming method comprises an extrusion process.

6. The low noise cable core according to claim 5, wherein a coating solution used in the solution-coating process for forming the first type conductive layer comprises: (a) polyester resin, (b) ethyl acetate, N,N-dimethylformamide, cyclohexanone, or Ethylene glycol monoethyl acetate, (c) graphite or graphene, and (d) Chemical additives;
wherein a volume percentage of (c) in the coating solution is no less than 3% and a volume percentage of (b) in the coating solution is no less than 20%.

7. The low noise cable core according to claim 5, wherein the second type conductive layer is a layer of extruded conductive PVC, a layer of extruded conductive PE, or a layer of extruded TPE.

8. The low noise cable core according to claim 1, further comprising: a metal shielding layer encapsulating the second type conductive layer.

9. A manufacturing method of a low noise cable core, comprising:
forming an insulated conductor comprising a conductive core and an insulation layer encapsulating the conductive core;
forming a first type conductive layer encapsulating the insulated conductor by way of a first forming method; and
forming a second type conductive layer encapsulating the first type conductive layer by way of a second forming method different from the first forming method.

10. The manufacturing method according to claim 9, wherein the first forming method comprises an extrusion process and the second forming method comprises a solution-coating process.

11. The manufacturing method according to claim 10, wherein the solution-coating process comprises:
coating a coating solution on the first type conductive layer, wherein the coating solution comprises: (a) polyester resin, (b) ethyl acetate, N,N-dimethylformamide, cyclohexanone, or Ethylene glycol monoethyl acetate, (c) graphite or graphene, and (d) Chemical additives, wherein a volume percentage of (c) in the coating solution is no less than 3% and a volume percentage of (b) in the coating solution is no less than 20%; and
drying the coating solution to form a cured layer, wherein the cured layer is the second type conductive layer.

12. The manufacturing method according to claim 9, wherein the first forming method comprises a solution-coating process and the second forming method comprises an extrusion process.

13. The manufacturing method according to claim 12, wherein the solution-coating process comprises:
coating a coating solution on the insulated conductor, wherein the coating solution comprises: (a) polyester resin, (b) ethyl acetate, N,N-dimethylformamide, cyclohexanone, or Ethylene glycol monoethyl acetate, (c) graphite or graphene, and (d) Chemical additives, wherein a volume percentage of (c) in the coating solution is no less than 3% and a volume percentage of (b) in the coating solution is no less than 20%; and
drying the coating solution to form a cured layer, wherein the cured layer is the first type conductive layer.

14. A low noise cable, comprising:
at least three strands of cable cores, wherein two or more of the adjacent cable cores are in contact with one another, and each of the cable cores comprises:
an insulated conductor comprising a conductive core and an insulation layer encapsulating the conductive core;
a first type conductive layer encapsulating the insulated conductor; and
a second type conductive layer encapsulating the first type conductive layer;
wherein the first type conductive layer and the second type conductive layer are respectively formed by way of a first forming method and a second forming method different from the first forming method; and
an outer sheath encapsulating said at least three strands of cable cores.
